(19) United States
(12) Patent Application Publication
(10) Pub. No.: US 2023/0013593 A1
(43) Pub. Date: Jan. 19, 2023

(54) MOTORCYCLE FAIRING ATTACHMENT APPARATUS

(71) Applicant: Paul Yaffe, Phoenix, AZ (US)

(72) Inventor: Paul Yaffe, Phoenix, AZ (US)

(21) Appl. No.: 17/867,949

(22) Filed: Jul. 19, 2022

Related U.S. Application Data
(60) Provisional application No. 63/223,513, filed on Jul. 19, 2021.

(51) Int. Cl. B62J 17/00; B62J 6/027

(52) U.S. Cl. CPC B62J 17/00; B62J 6/027

(57) ABSTRACT

A fairing attachment assembly for a motorcycle fairing for a motorcycle having a front fork assembly comprising an upper end and a lower end is disclosed. The attachment assembly includes: a fairing comprising a top portion and a bottom portion; a lower fairing support; an upper fairing support plate; a lower fairing support bracket; and a fairing hanging bracket. The lower fairing support is adapted to be removably attached to said front fork assembly lower end, so as to be extending laterally away from the front fork assembly lower end. The upper fairing support plate is adapted to be removably attached to said front fork assembly upper end, so as to be extending laterally away from the front fork assembly upper end. The fairing hanging bracket is removably attached to said upper fairing support plate and to said top portion.

### RELATED APPLICATION DATA

This application claims the priority benefit of U.S. Provisional Application Ser. No. 63/223,513, filed Jul. 19, 2021, which is hereby incorporated in its entirety herein by reference.

### BACKGROUND

Some motorcycles include a fairing assembly located near a top portion of the front fork assembly. The fairing assembly may include one or more headlamps, turn signals, gauges, or other instrumentation, or one or more mirrors, or a combination thereof. Use of fairings may also be desirable in order to shield a user from wind and other elements. Many existing fairings mount to the front fork assembly of a motorcycle. The result is that many such fairing assemblies must be created to match the specific dimensions of a particular motorcycle. These fairings are often not interchangeable to other motorcycles of different sizes. Further, existing fairings cannot easily be adjusted to different angles relative to the user.

### SUMMARY

The present disclosure includes disclosure of an apparatus for attaching a motorcycle fairing to a motorcycle. The apparatus may be attached as described herein to a motorcycle's front fork assembly that typically comprises what is referred to herein as front fork upper and lower ends, and a triple tree comprising an upper triple tree and a lower triple tree, as will typically be present in motorcycle arrangements to which the invention may be applied.

Such an apparatus includes a fairing attachment assembly for a motorcycle fairing for a motorcycle having a front fork assembly comprising an upper end and a lower end, the attachment assembly includes a fairing including a top portion and a bottom portion, a lower fairing support, an upper fairing support plate, a lower fairing support bracket, and a fairing hanging bracket, the lower fairing support is adapted to be removably attached to the front fork assembly lower end, so as to be extending laterally away from the front fork assembly lower end, the upper fairing support plate is adapted to be removably attached to said front fork assembly upper end, so as to be extending laterally away from the front fork assembly upper end, the fairing hanging bracket is adapted to be removably attached to said upper fairing support plate and to said top portion of said fairing, the lower fairing support bracket is adapted to be removably attached to said lower fairing support, once assembled onto the motorcycle, the attachment assembly supports said fairing forward of said front fork assembly of said motorcycle. In an aspect of such an embodiment the motorcycle fairing attachment assembly further includes a headlight support attached to the fairing hanging bracket. In an aspect of such an embodiment the angle of the headlight support relative to the front fork assembly is adjustable. In an aspect of such an embodiment the fairing hanging bracket comprises a fairing attachment portion and a vehicle attachment portion. In an aspect of such an embodiment the fairing attachment portion is angled upward forming an acute angle relative to the vehicle attachment portion, thereby creating a surface to facilitate attachment to the fairing. In an aspect of such an embodiment, the front fork assembly comprises an upper triple tree and a lower triple tree. In an aspect of such an embodiment, the lower fairing support attaches to the lower triple tree and the upper fairing support plate attaches to the upper triple tree.

In at least one embodiment, the motorcycle fairing attachment apparatus includes an attachment apparatus comprising an upper attachment portion and a lower attachment portion, a fairing, and a motorcycle comprising a triple tree and a front fork assembly, the attachment apparatus connects the front fork assembly of the motorcycle to the fairing while allowing free movement of said front fork assembly and triple tree. In this regard, the motorcycle frame is attached to the triple tree (with attached front fork assembly) so as to permit the triple tree's rotational movement with respect to the motorcycle frame for steering. Such a range of so-called “lock-to-lock” range of rotation is typically in the range of from about 60 degrees to about 85 degrees. The attachment apparatus of such embodiments connects the front fork assembly of the motorcycle to the fairing while allowing free rotational movement of the triple tree with respect to the motorcycle frame without interference with such rotational movement. In an aspect of such an embodiment the motorcycle fairing attachment assembly further includes a headlight support attached to the fairing hanging bracket. In an aspect of such an embodiment the angle of the headlight support relative to the front fork assembly is adjustable. In an aspect of such an embodiment the fairing hanging bracket comprises a fairing attachment portion and a vehicle attachment portion. In an aspect of such an embodiment the fairing attachment portion is angled upward forming an acute angle relative to the vehicle attachment portion, thereby creating a surface to facilitate attachment to the fairing. In an aspect of such an embodiment, the front fork assembly comprises an upper triple tree and a lower triple tree. In an aspect of such an embodiment, the lower fairing support attaches to the lower triple tree and the upper fairing support plate attaches to the upper triple tree.

In at least one embodiment, such a method for attaching a fairing to a motorcycle includes without regard to order, the steps of attaching a lower fairing support member to the lower end of the front fork assembly of a motorcycle, attaching an upper fairing support plate to the upper end of the front fork assembly of a motorcycle, and further engaging a fairing, including a fairing hanging bracket and a lower fairing support bracket, with said front fork assembly of the motorcycle, such that said lower fairing support member of the motorcycle engages said lower fairing support bracket of the fairing and said upper faring support plate of the motorcycle engages the fairing hanging bracket of said fairing. In an aspect of such an embodiment, the front fork assembly of the motorcycle is connected to the fairing while allowing free movement of said front fork assembly and triple tree. In an aspect of such an embodiment, the headlight support is adjustably attached to the fairing support bracket.

The present disclosure includes a fairing attachment assembly for a motorcycle fairing for a motorcycle having an upright portion comprising an upper end and a lower end, the attachment assembly comprising: (a) a fairing comprising a top portion and a bottom portion; (b) a lower fairing support; (c) an upper fairing support plate; (d) a lower fairing support bracket; and (e) a fairing hanging bracket.

The fairing attachment assembly permits the lower fairing support to be removably attached to the upright portion lower end, so as to be extending laterally away from the upright portion lower end. The upper fairing support plate is adapted to be removably attached to the upright portion upper end, so as to be extending laterally away from the upright portion upper end. The fairing hanging bracket is adapted to be removably attached to the upper fairing support plate and to the top portion of the fairing. The lower fairing support bracket is adapted to be removably attached to the motorcycle fairing and to the lower fairing support.

The present disclosure includes a fairing attachment assembly for a motorcycle fairing for a motorcycle having an upright portion comprising an upper end and a lower end, the attachment assembly comprising: (a) a fairing comprising a top portion and a bottom portion; (b) a lower fairing support and lower fairing support bracket that are integrated into a single piece; (c) an upper fairing support plate; and (d) a fairing hanging bracket. The upper fairing support plate is adapted to be removably attached to the upright portion upper end, so as to be extending laterally away from the upright portion upper end. The fairing hanging bracket is adapted to be removably attached to the upper fairing support plate and to the top portion of the fairing. The integrated lower fairing support and lower fairing support bracket is adapted to be removably attached upright portion lower end and the motorcycle fairing.

Once assembled onto the motorcycle, the attachment assembly supports the fairing forward of the upright portion of the motorcycle.

The motorcycle fairing attachment assembly may further comprise a headlight support attached to the fairing hanging bracket.

The motorcycle fairing attachment assembly may include a fairing hanging bracket that comprises a fairing attachment portion and a vehicle attachment portion.

The motorcycle fairing attachment assembly may provide that the fairing attachment portion is angled upward forming an acute angle relative to the vehicle attachment portion, thereby creating a surface to facilitate attachment to the fairing.

The motorcycle fairing attachment assembly may include a lower fairing support that further comprises a lower fairing support bracket.

The present disclosure further includes a motorcycle fairing attachment apparatus comprising: (1) an attachment apparatus comprising an upper attachment portion and a lower attachment portion; (2) a fairing; and (3) a motorcycle comprising a triple tree and an upright portion; such that the attachment apparatus connects the upright portion of the motorcycle to the fairing while allowing free movement of the triple tree and front fork assembly.

The present disclosure further includes a method of attaching a fairing to a motorcycle comprising, without regard to order: (1) attaching a lower fairing support member to the lower end of the upright portion of a motorcycle; (2) attaching an upper fairing support plate to the upper end of the upright portion of a motorcycle; and further (3) engaging a fairing, comprising a fairing hanging bracket and a lower fairing support bracket, with the upright portion of the motorcycle, such that the lower fairing support member of the motorcycle engages the lower fairing support bracket of the fairing and the upper faring support plate of the motorcycle engages the fairing hanging bracket of the fairing.

The upright portion of the motorcycle is thereby connected to the fairing while allowing free movement of the triple tree and front fork assembly.

### BRIEF DESCRIPTION OF THE FIGURES

The embodiments described herein and other features, advantages, and disclosures contained herein, and the manner of attaining them, will be better understood from the following description in conjunction with the accompanying drawing figures, in which like reference numerals identify like elements, and wherein:

FIG. 1 is an upper perspective view of a lower fairing support according to an embodiment of the present disclosure;

FIG. 2 is an upper perspective view of a lower fairing support according to an embodiment of the present disclosure;

FIG. 3 is top view of a lower fairing support according to an embodiment of the present disclosure;

FIG. 4 is a bottom view of a lower fairing support according to an embodiment of the present disclosure;

FIG. 5 is a side view of a lower fairing support according to an embodiment of the present disclosure;

FIG. 6 is a side view of a lower fairing support according to an embodiment of the present disclosure;

FIG. 7 is an upper perspective view of an upper fairing support plate according to an embodiment of the present disclosure;

FIG. 8 is an upper perspective view of an upper fairing support plate according to an embodiment of the present disclosure;

FIG. 9 is a bottom view of an upper fairing support plate according to an embodiment of the present disclosure;

FIG. 10 is a top view of an upper fairing support plate according to an embodiment of the present disclosure;

FIG. 11 is a side view of an upper fairing support plate according to an embodiment of the present disclosure;

FIG. 12 is a side view of an upper fairing support plate according to an embodiment of the present disclosure;

FIG. 13 is a front view of an upper fairing support plate according to an embodiment of the present disclosure;

FIG. 14 is a rear view of an upper fairing support plate according to an embodiment of the present disclosure;

FIG. 15 is an upper perspective view of a lower fairing support bracket according to an embodiment of the present disclosure;

FIG. 16 is an upper perspective view of a lower fairing support bracket according to an embodiment of the present disclosure;

FIG. 17 is a bottom view of a lower fairing support bracket according to an embodiment of the present disclosure;

FIG. 18 is a top view of a lower fairing support bracket to an embodiment of the present disclosure;

FIG. 19 is a side view of a lower fairing support bracket according to an embodiment of the present disclosure;

FIG. 20 is a side view of a lower fairing support bracket according to an embodiment of the present disclosure;

FIG. 21 is a front view of a lower fairing support bracket according to an embodiment of the present disclosure;

FIG. 22 is a rear view of a lower fairing support bracket to an embodiment of the present disclosure;

FIG. 23 is an upper perspective view of a headlight support according to an embodiment of the present disclosure;

FIG. 24 is an upper perspective view of a headlight support according to an embodiment of the present disclosure;

FIG. 25 is a bottom view of a headlight support according to an embodiment of the present disclosure;

FIG. 26 is a top view of a headlight support according to an embodiment of the present disclosure;

FIG. 27 is a side view of a headlight support according to an embodiment of the present disclosure;

FIG. 28 is a side view of a headlight support according to an embodiment of the present disclosure;

FIG. 29 is a front view of a headlight support according to an embodiment of the present disclosure;

FIG. 30 is a rear view of a headlight support according to an embodiment of the present disclosure;

FIG. 31 is an upper perspective view of a fairing hanging bracket according to an embodiment of the present disclosure;

FIG. 32 is an upper perspective view of a fairing hanging bracket according to an embodiment of the present disclosure;

FIG. 33 is a bottom view of a fairing hanging bracket according to an embodiment of the present disclosure;

FIG. 34 is a top view of a fairing hanging bracket according to an embodiment of the present disclosure;

FIG. 35 is a side view of a fairing hanging bracket according to an embodiment of the present disclosure;

FIG. 36 is a side view of a fairing hanging bracket according to an embodiment of the present disclosure;

FIG. 37 is a front view of a fairing hanging bracket according to an embodiment of the present disclosure;

FIG. 38 is a rear view of a fairing hanging bracket according to an embodiment of the present disclosure;

FIG. 39 is an upper perspective view of a fairing attachment apparatus according to an embodiment of the present disclosure;

FIG. 40 is an upper perspective view of a fairing attachment apparatus according to an embodiment of the present disclosure;

FIG. 41 is a bottom view of a fairing attachment apparatus according to an embodiment of the present disclosure;

FIG. 42 is a top view of a fairing attachment apparatus according to an embodiment of the present disclosure;

FIG. 43 is a side view of a fairing attachment apparatus according to an embodiment of the present disclosure;

FIG. 44 is a side view of a fairing attachment apparatus according to an embodiment of the present disclosure;

FIG. 45 is a front view of a fairing attachment apparatus according to an embodiment of the present disclosure;

FIG. 46 is a rear view of a fairing attachment apparatus according to an embodiment of the present disclosure; and

FIG. 47 is an upper perspective view of a fairing attachment apparatus attached to a motorcycle according to an embodiment of the present disclosure.

Appendix A describes and depicts the stepwise attachment of a fairing attachment apparatus according to an embodiment of the present disclosure.

Appendix B describes and depicts the stepwise attachment of a fairing attachment apparatus according to another embodiment of the present disclosure.

Appendix C describes and depicts the stepwise attachment of a fairing attachment apparatus according to another embodiment of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

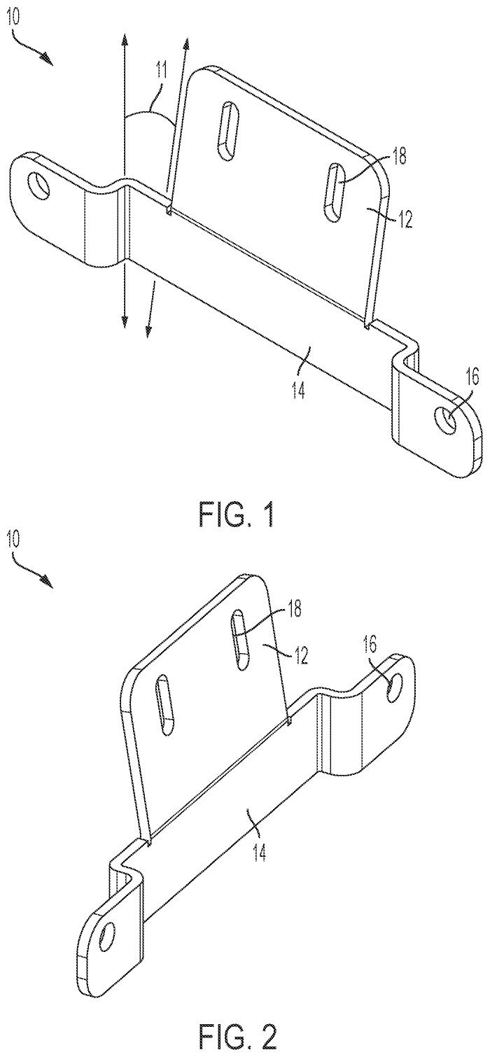

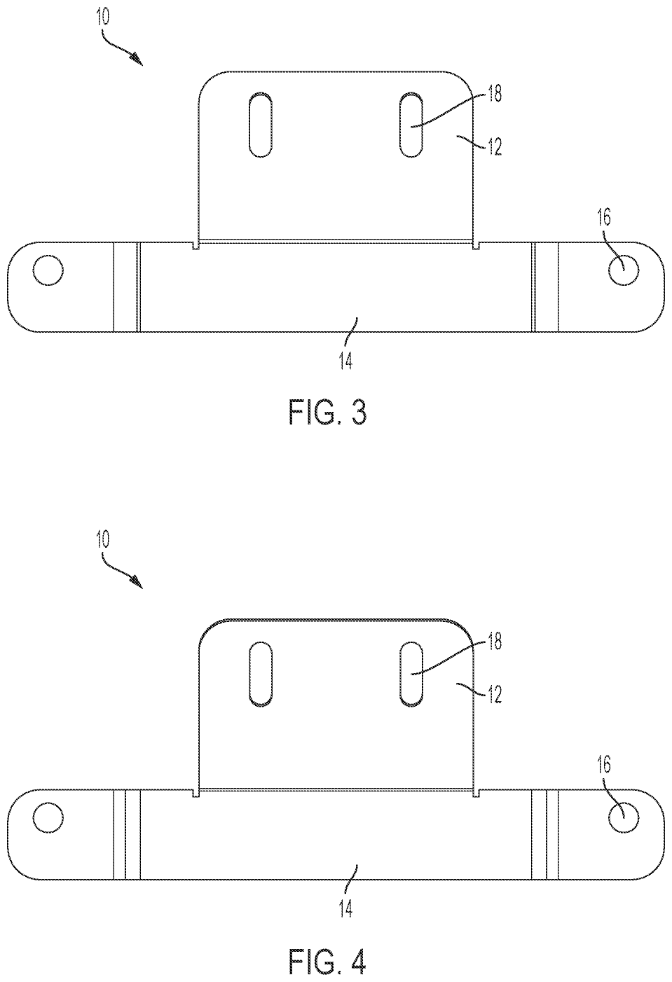

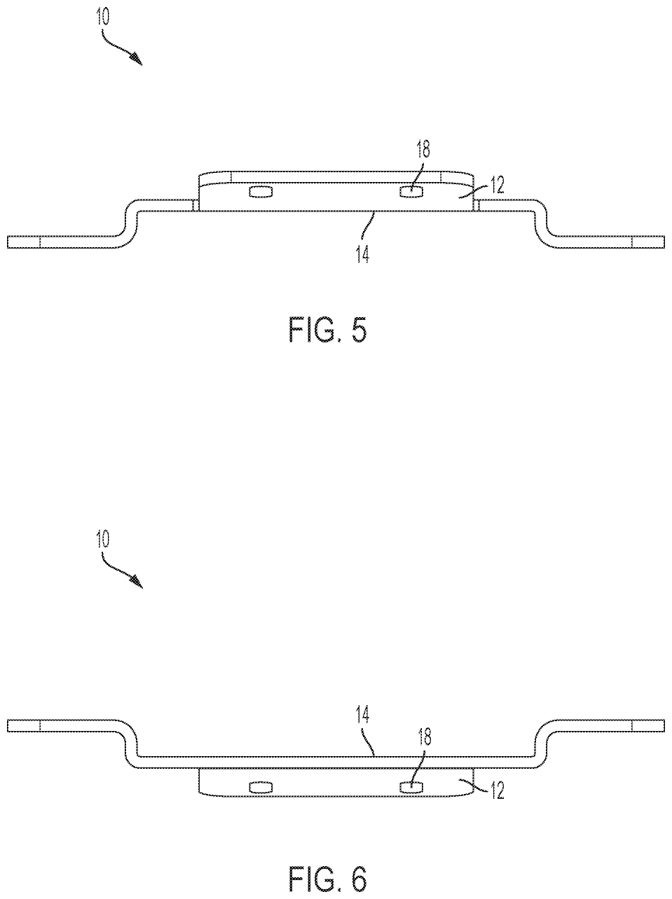

Referring now to the figures, FIGS. 1-6, show a lower fairing support 10 according to an embodiment of the present disclosure. According to an embodiment, the lower fairing support 10 includes a so-called vertical portion adapted to be installed so as to be generally vertical with respect to the ground once installed on the fork assembly, and an angled portion relatively angled with respect to the vertical portion, and thus held at an angle thereto once installed on the fork assembly. See angle 11 in FIG. 1. According to an embodiment, the lower fairing support 10 includes a fairing attachment portion 12 and a vehicle attachment portion 14 in this case manufactured so as to form angle 11 with respect to one another. According to an embodiment, the lower fairing support 10 includes at least one aperture 16 adapted to accept a fixture such as a bolt extending therethrough permitting attachment to the lower fairing portion. According to an embodiment, the lower fairing support 10 includes at least one notch 18 which may be an elongated aperture adapted to accept a fixture such as a bolt extending therethrough permitting adjustment with respect to that fixture once installed onto the vehicle.

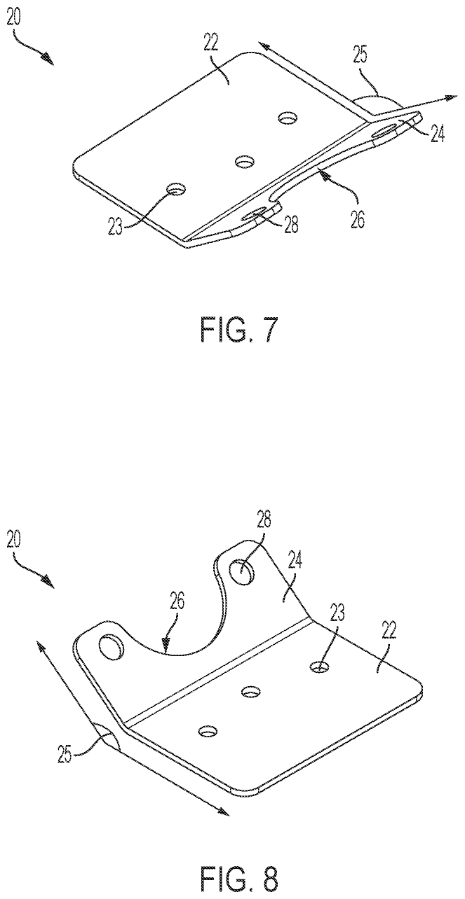

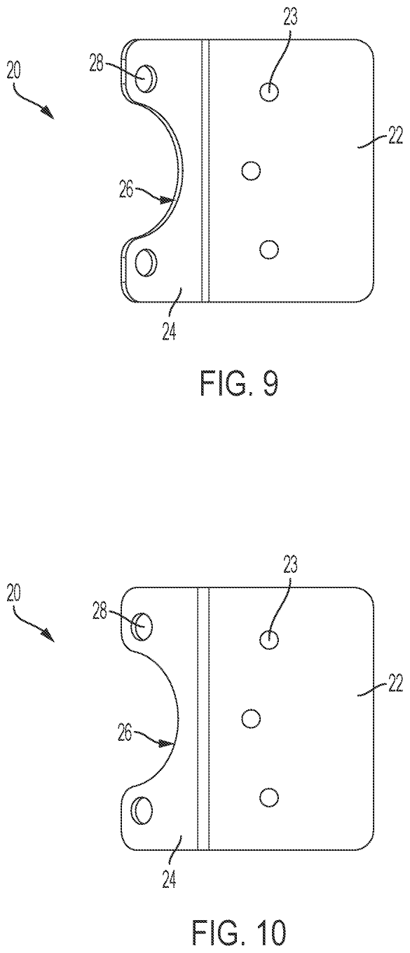

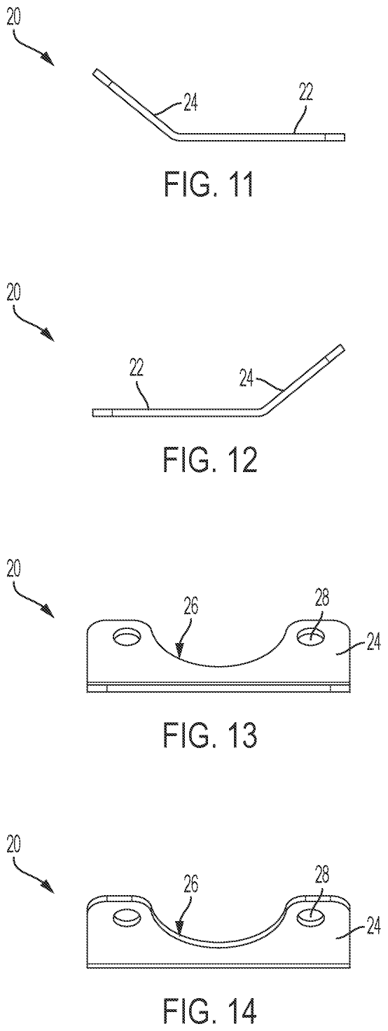

FIGS. 7-14 show an upper fairing support plate 20 according to an embodiment of the present disclosure. According to an embodiment, the upper fairing support plate 20 includes a fairing attachment portion 22. According to an embodiment, the upper fairing support plate 20 includes a vehicle attachment portion 24. The fairing attachment portion 22 and the vehicle attachment portion 24 are, in this embodiment, manufactured so as to form angle 25 with respect to one another. According to an embodiment, the upper fairing support plate 20 includes a triple tree indentation 26 in vehicle attachment portion 24 and at least one aperture 28 adapted to accept a fixture such as a bolt extending therethrough permitting attachment to the triple tree as described herein. According to an embodiment, the fairing attachment portion 22 includes at least one aperture 23 adapted to accept a fixture such as a bolt extending therethrough permitting attachment to the upper fairing portion. According to an embodiment the angle 25 is acute. According to an embodiment the angle 25 is obtuse. According to an embodiment the angle 25 forms a right angle.

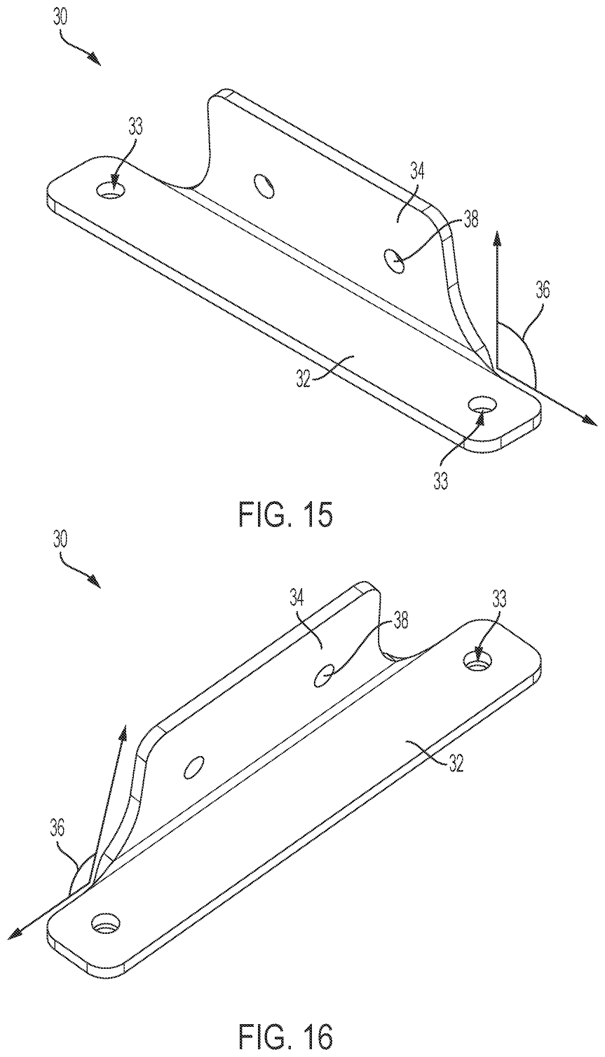

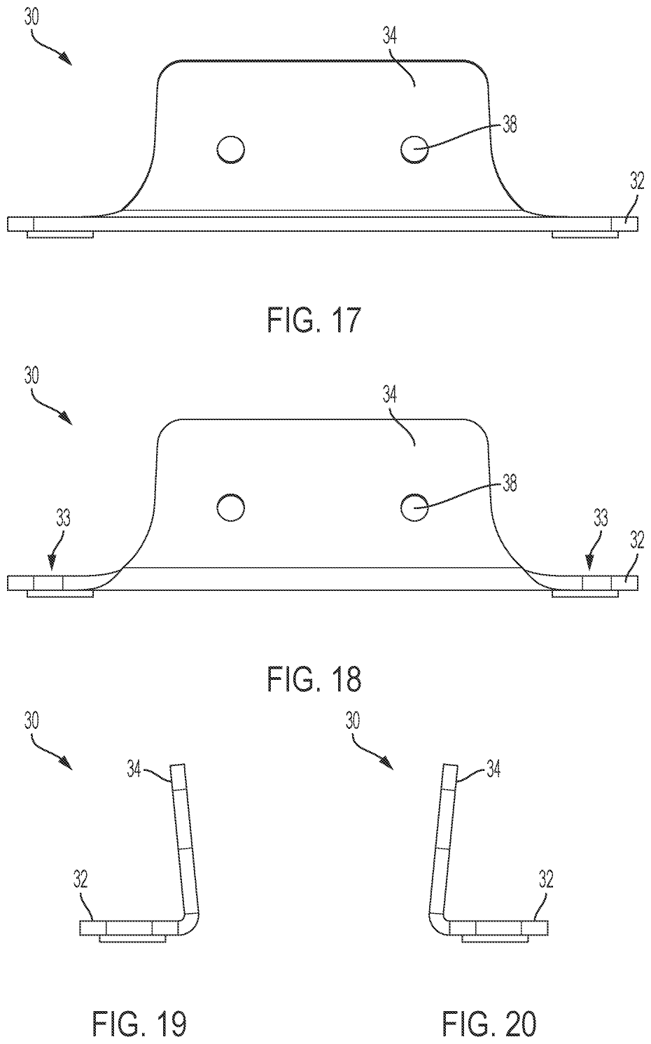

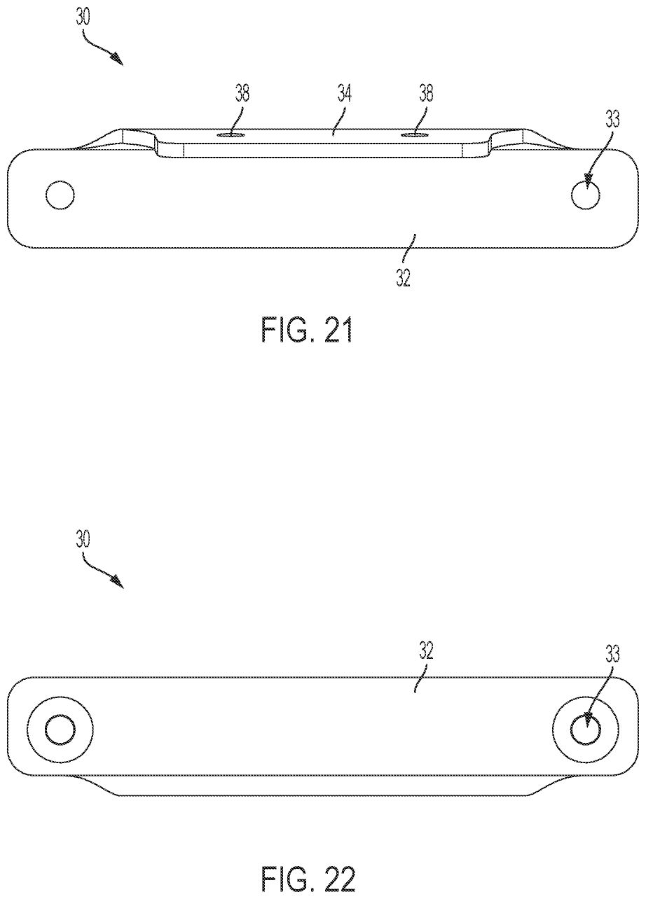

FIGS. 15-22 show a lower fairing support bracket 30 according to an embodiment of the present disclosure. According to an embodiment, the lower fairing support bracket 30 includes a fairing attachment portion 32 including at least one aperture 33 adapted to accept a fixture such as a bolt extending therethrough permitting attachment to the fairing as described herein. According to an embodiment, the lower fairing support bracket 30 includes a vehicle attachment portion 34. According to an embodiment, the d of lower fairing support bracket 30 includes at least one aperture 38 adapted to accept a fixture such as a bolt extending therethrough permitting attachment to the motorcycle 70 as described herein. According to an embodiment, the fairing attachment portion 32 and the vehicle attachment portion 34 are manufactured so as to connect, forming an angle 36. According to an embodiment, the lower fairing support bracket 30 is integrated with the lower fairing support 10 as a single piece that is shaped to engage with the lower triple tree 78 and the motorcycle fairing 72 at the fairing attachment portion 30.

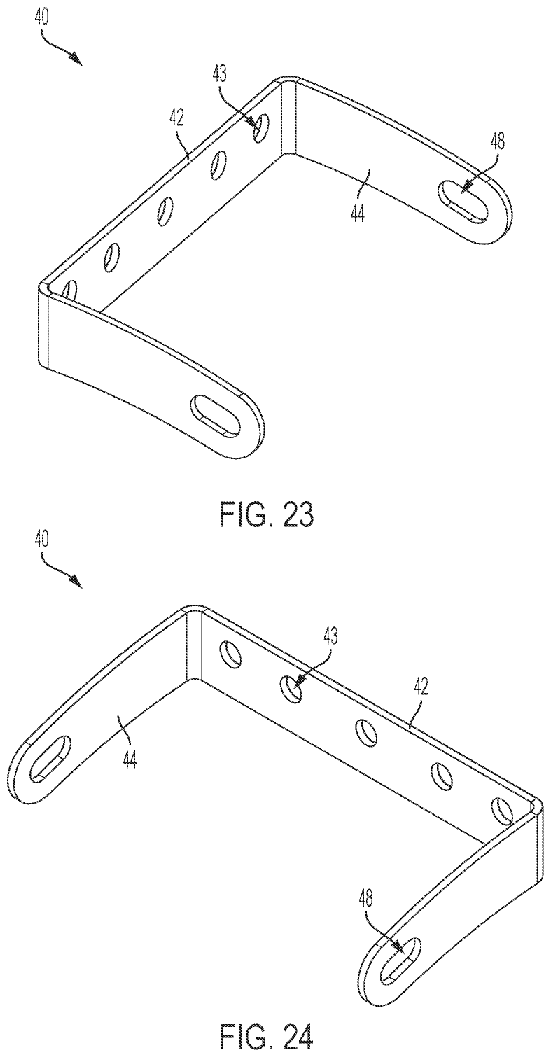

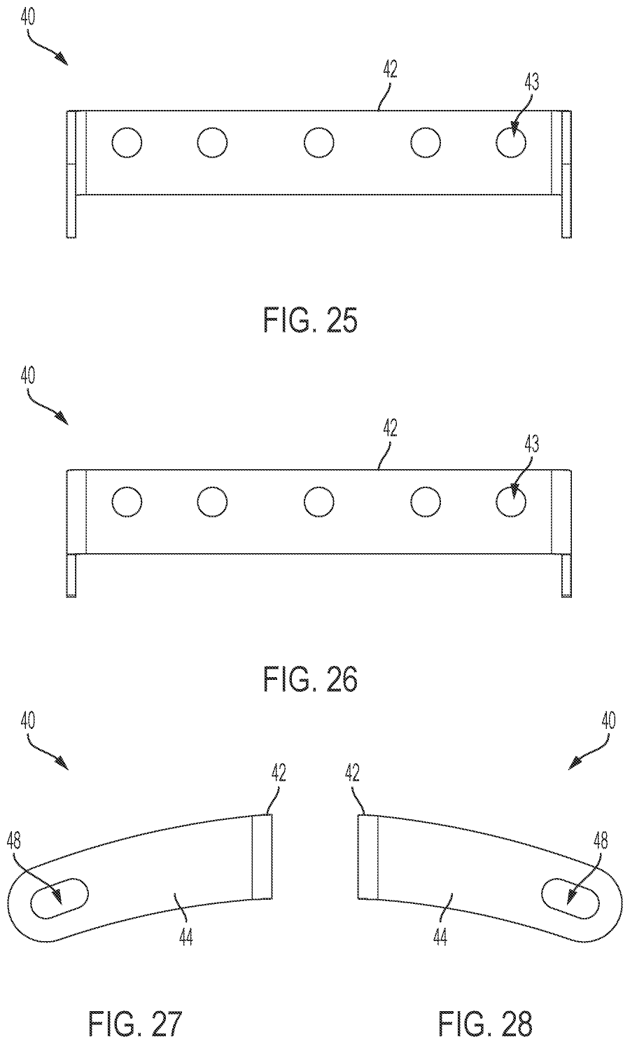

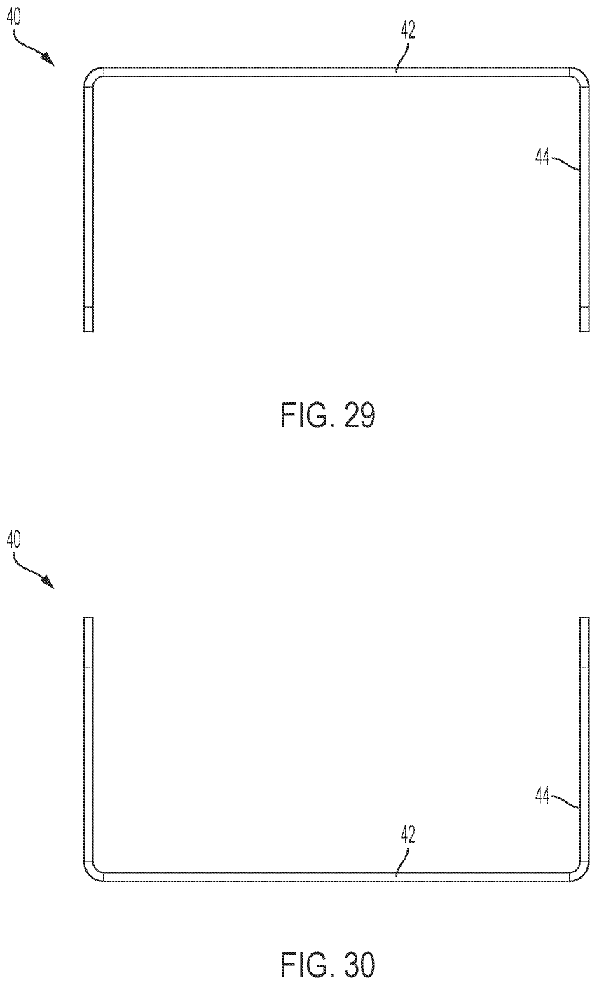

FIGS. 23-30 show a headlight support 40 according to an embodiment of the present disclosure. According to an embodiment, the headlight support 40 includes a fairing attachment portion 42 one or more apertures 43 on the headlight support adapted to accept a fixture such as a bolt extending therethrough permitting attachment to the fairing hanging bracket 50. According to an embodiment, the headlight support 40 includes a headlight attachment portion 44. According to an embodiment, the headlight support 40 includes at least one aperture 16. According to an embodiment, the one or more apertures 43 on fairing attachment portion 42 of the headlight support 40 and the one or more apertures 58 on the vehicle attachment portion 54 of fairing hanging bracket 50 are configured to align to permit the attachment of the headlight support 40 to the fairing hanging bracket 50 via an attachment means (not shown). According to an embodiment, the headlight attachment portion 44 of headlight support 40 includes at least one notch 48 which may be an elongated aperture adapted to accept a fixture such as a bolt extending therethrough permitting adjustment with respect to that fixture once installed onto the vehicle. According to an embodiment, the one or more notches 48 on the headlight attachment portion 44 of headlight support 40 are configured to attach headlight support 40 to a headlight (not shown) via an attachment means (not shown).

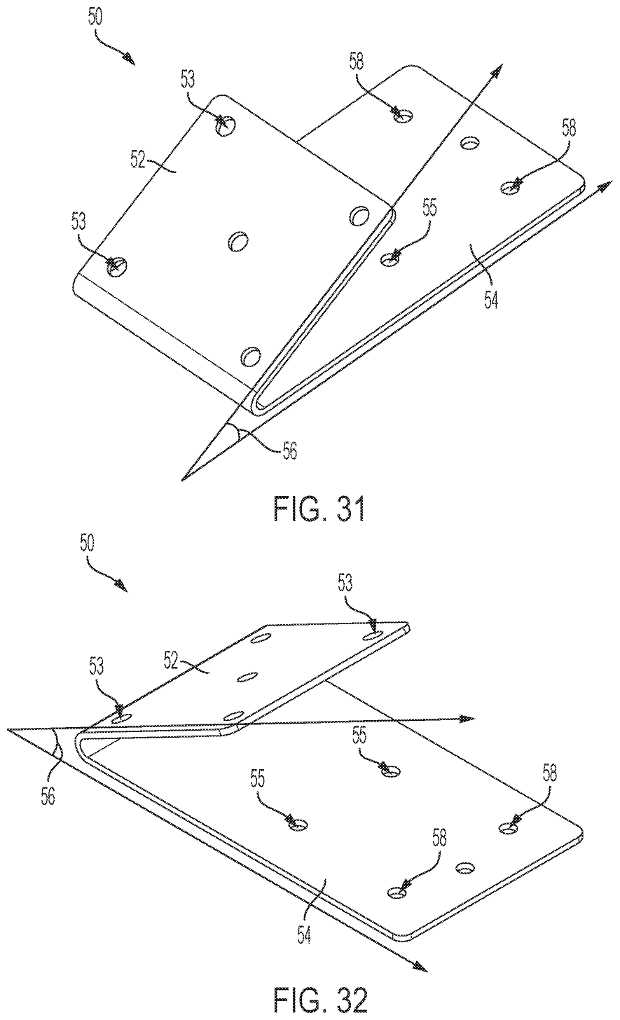

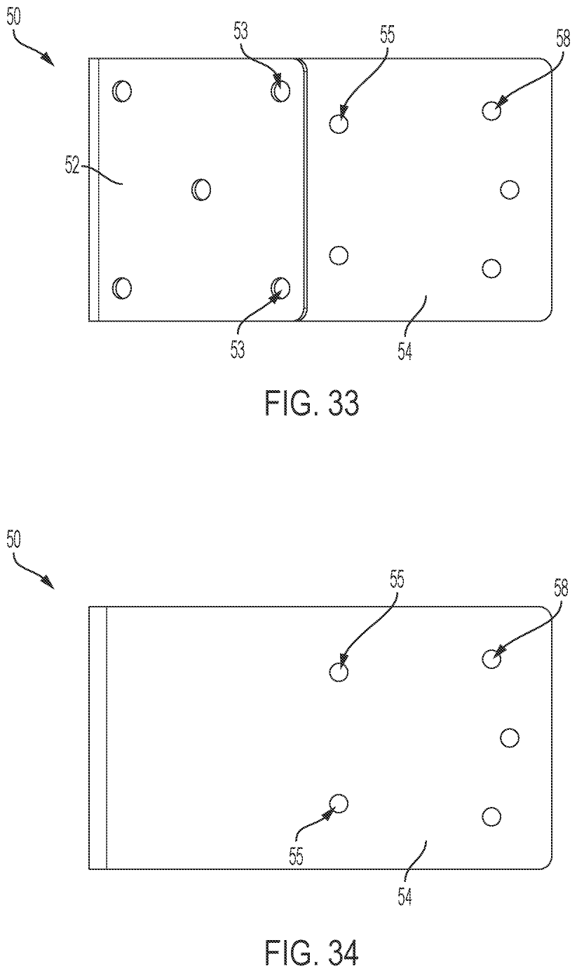

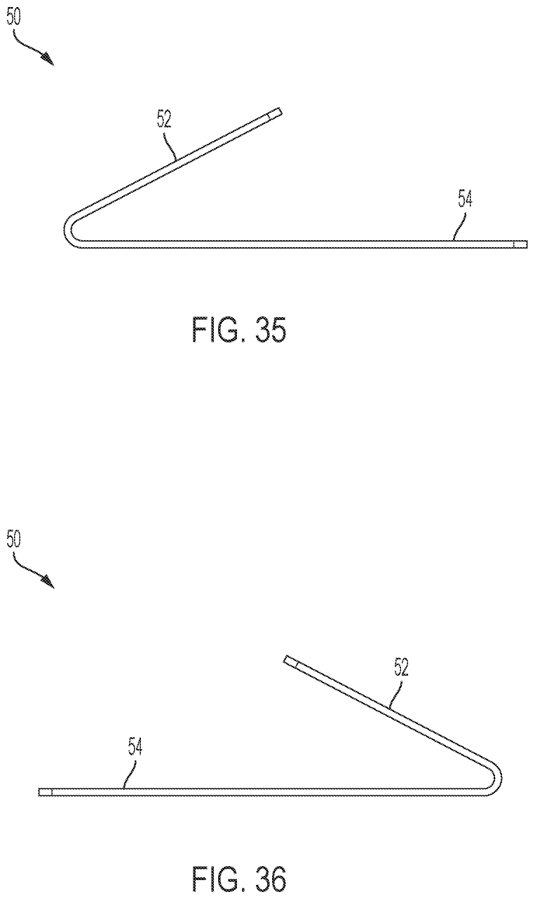

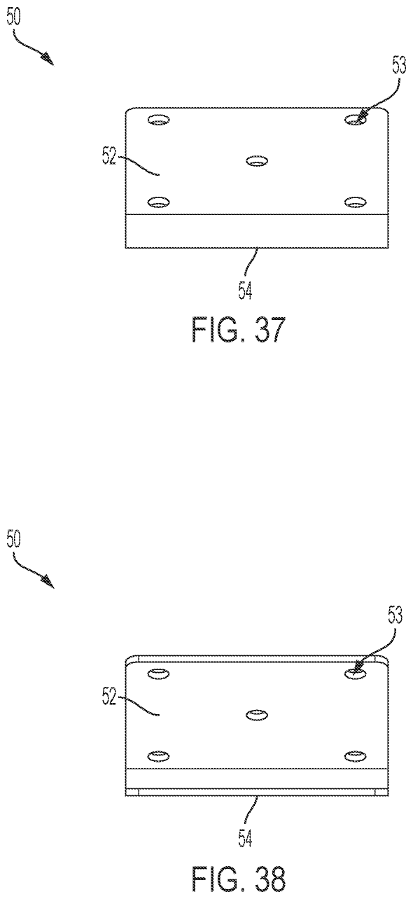

FIGS. 31-38 show a fairing hanging bracket 50 according to an embodiment of the present disclosure. According to an embodiment, fairing hanging bracket 50 includes a fairing attachment portion 52. According to an embodiment, the fairing hanging bracket 50 includes a vehicle attachment portion 54, including at least one aperture 55 and at least one aperture 58. According to an embodiment, the fairing attachment portion 52 of fairing hanging bracket 50 includes at least one aperture 53. According to an embodiment, the fairing attachment portion 52 and the vehicle attachment portion 54 connect, forming an angle 56. According to an embodiment, the angle 56 is obtuse. According to an embodiment, the angle 56 is acute.

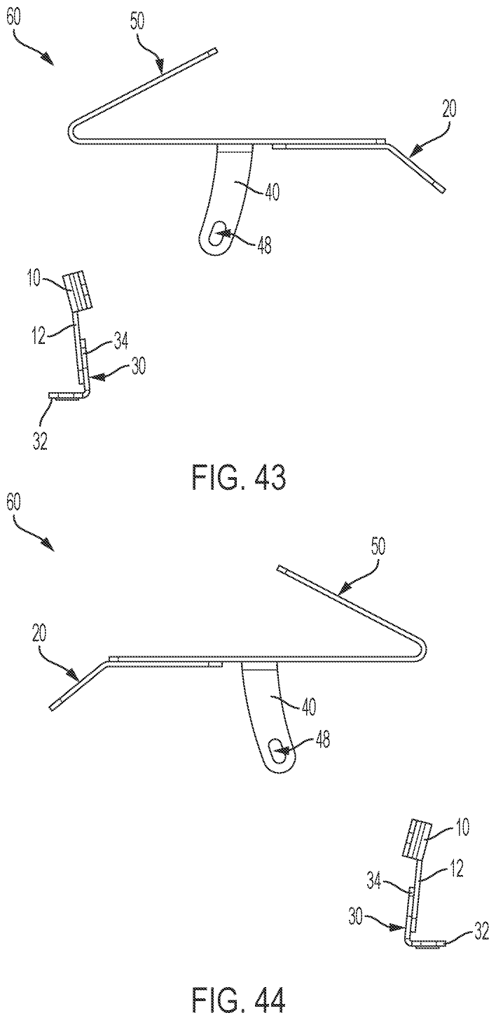

The arrangement of assembled upper fairing support plate 20, headlight support 40 and fairing hanging bracket 50 may be appreciated from FIG. 43. This Figure shows the fairing attachment portion 22 mated with vehicle attachment portion 54 (through fixtures extending through respective at least one aperture 23 and at least one aperture 58), headlight support 40 mated with vehicle attachment portion 54 (through fixtures extending through respective at least one aperture 43 and at least one aperture 55). This Figure shows fairing attachment portion 52 of fairing hanging bracket 50 awaiting attachment of the fairing via a fixture extending through at least one aperture 53.

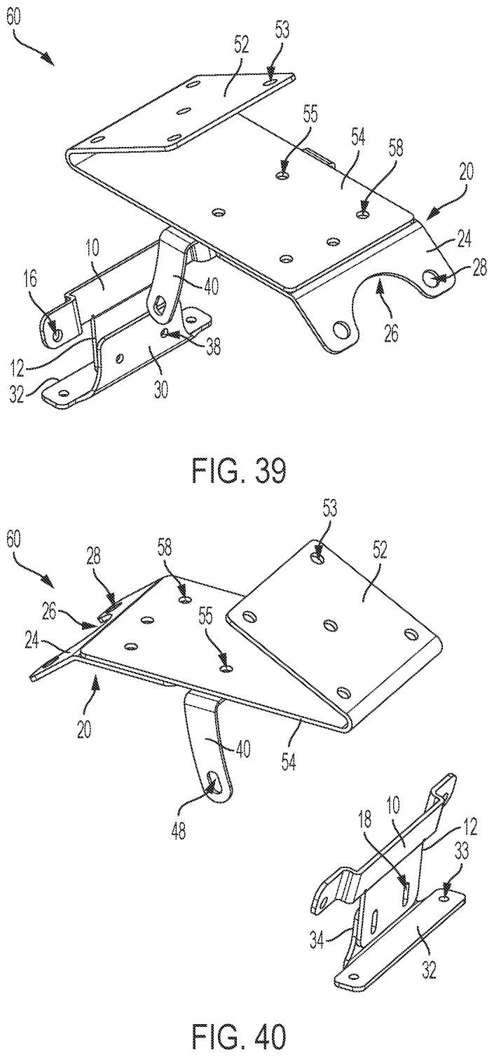

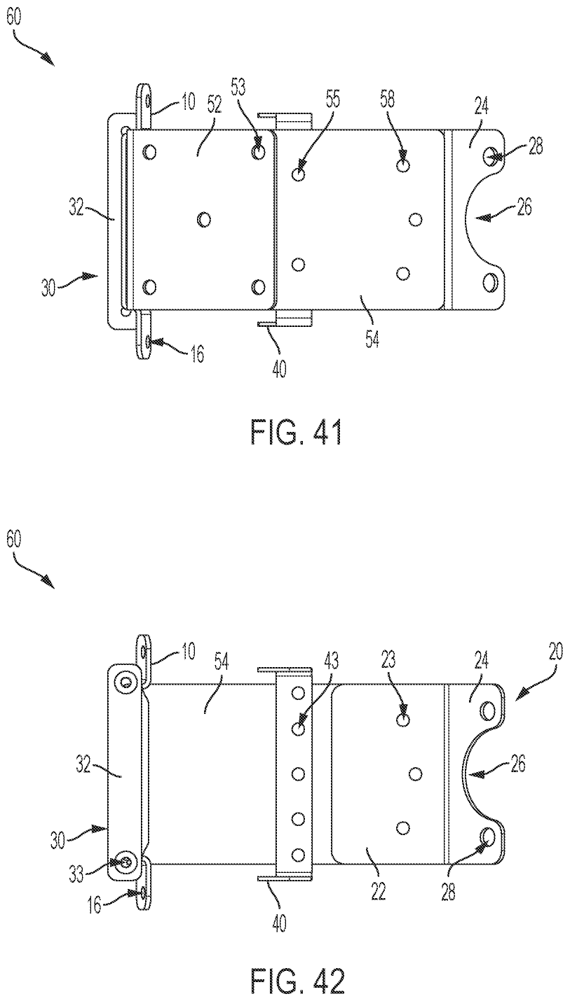

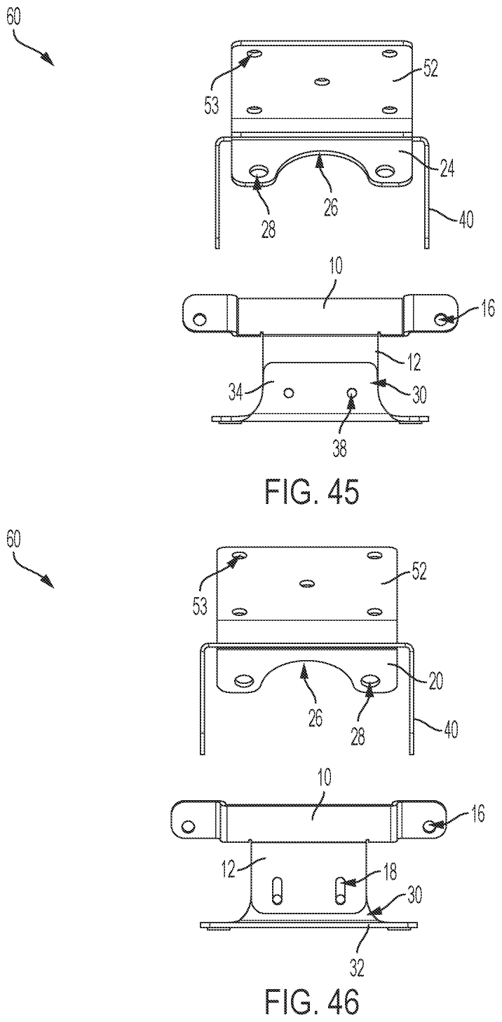

FIGS. 39-46 show a fairing attachment apparatus 60 according to an embodiment of the present disclosure. According to an embodiment, the lower fairing support 10 attaches to the lower fairing support bracket 30. According to an embodiment, the one or more apertures 18 on the lower fairing support 10 and the one or more apertures 38 on the lower fairing support bracket 30 are configured to attach the lower fairing support 10 to the lower fairing support bracket 30 via an attachment means (such as through fixtures extending through respective at least one aperture 18 and at least one aperture 38, not shown). According to an embodiment, the upper fairing support plate 20 attaches to the fairing hanging bracket 50 as described above, fairing attachment portion 22 being mated with vehicle attachment portion 54 (through fixtures extending through respective at least one aperture 23 and at least one aperture 58). According to an embodiment, the headlight support 40 is configured to attach to the fairing hanging portion 50 via an attachment means (not shown). According to an embodiment, the headlight support 40 is configured to attach to the upper fairing support plate 20 via an attachment means (not shown). The attachment means may be any suitable attachment means including but not limited to screws, bolts, or pins.

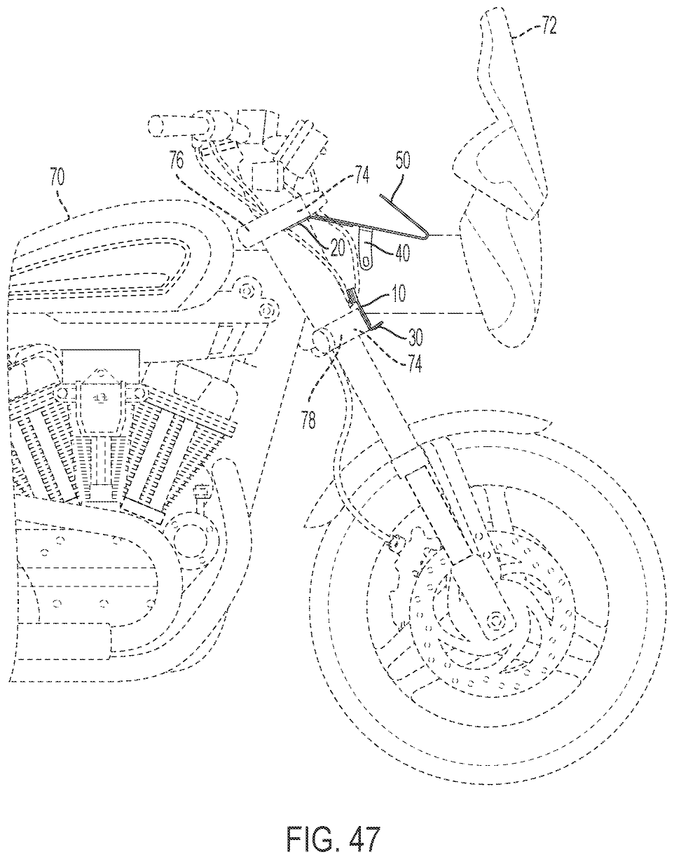

FIG. 47 shows the fairing attachment apparatus 60 attached to a motorcycle 70 and a fairing 72. The fairing attachment apparatus 60 attaches to the front fork assembly of the motorcycle 70 via the vehicle attachment portion 34 while still allowing the free movement of the triple tree 74. According to an embodiment, the upper end of the fairing 72 attaches to the fairing hanging bracket 50. According to an embodiment, the lower end of the fairing 72 attaches to the lower fairing support bracket 30. According to an embodiment, the lower fairing support bracket 30 is configured to attach to the lower fairing support 10. According to an embodiment, the lower fairing support 10 is configured to attach to the motorcycle 70. According to an embodiment, the fairing hanging bracket 50 is configured to attach to the upper fairing support plate 20. According to an embodiment the upper fairing support plate 20 attaches to the motorcycle 70 while allowing free movement of the triple trees 74. The free movement of the triple tree 74 allows for the wheels of the motorcycle 70 to turn freely and independently from the fairing 72.

According to an embodiment of the present invention, the triple trees 74 includes an upper triple tree 76 and a lower triple tree 78. In an embodiment, the lower fairing support bracket 30 attaches to the lower triple tree 78 and the upper fairing support plate 20 attaches to the upper triple tree 76. According to an embodiment, the headlight support 40 is adjustably connected to the attachment apparatus such that the angle of the headlight support 40 relative to the triple trees 74 is adjustable. The upright portion of the motorcycle is thereby connected to the fairing while allowing free movement of the triple tree.

It will be understood by one of skill in the art that a motorcycle's front fork assembly typically comprises what is referred to herein as front fork upper and lower ends, and a triple tree comprising an upper triple tree 76 and a lower triple tree 78. Embodiments of the present invention may be applied to such motorcycle arrangements as described herein.

The assembly of the fairing attachment apparatus 60 is shown in Appendix A hereto that describes and depicts the stepwise attachment of upper fairing support plate 20 to motorcycle 70 which in turn attaches to the fairing hanging bracket 50. Similarly, Appendix A hereto describes and depicts the attachment of the lower fairing support 10 to motorcycle 70 which in turn attaches to the lower fairing support bracket 30. Appendix A further describes and depicts the attachment of the upper end of the fairing 72 to fairing hanging bracket 50, and the attachment of the lower fairing support bracket 30 to the lower end of the fairing 72.

Another similar embodiment is described and depicted in Appendix B that shows a fairing attachment apparatus similar to fairing attachment apparatus 60 except that the lower fairing support is attached to the underside of the lower triple tree 78 rather than the forward side (as shown in Step 3 of Appendix B), along with the provision of a lower fairing support bracket shaped to engage the lower end of the fairing (as shown in Steps 7a and 7b of Appendix B).

Another similar embodiment is described and depicted in Appendix C that shows a fairing attachment apparatus similar to fairing attachment apparatus 60 except that the lower fairing support and lower fairing support bracket are comprised in a single piece that is shaped to engage with the lower triple tree 78 and the motorcycle fairing 72.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

I claim:

1. A fairing attachment assembly for a motorcycle fairing for a motorcycle having a front fork assembly comprising an upper end and a lower end, the attachment assembly comprising:
a. a fairing comprising a top portion and a bottom portion;
b. a lower fairing support;
c. an upper fairing support plate;
d. a lower fairing support bracket; and
e. a fairing hanging bracket
wherein said lower fairing support is adapted to be removably attached to said front fork assembly lower end, so as to be extending laterally away from the front fork assembly lower end;
wherein the upper fairing support plate is adapted to be removably attached to said front fork assembly upper end, so as to be extending laterally away from the front fork assembly upper end;
wherein said fairing hanging bracket is adapted to be removably attached to said upper fairing support plate and to said top portion of said fairing;
wherein said lower fairing support bracket is adapted to be removably attached to said lower fairing support;
whereby, once assembled onto said motorcycle, said attachment assembly supports said fairing forward of said front fork assembly of said motorcycle.

2. The motorcycle fairing attachment assembly of claim 1 further comprising a headlight support attached to the fairing hanging bracket.

3. The motorcycle fairing attachment assembly of claim 2 wherein the angle of the headlight support relative to the front fork assembly is adjustable.

4. The motorcycle fairing attachment assembly of claim 1 wherein the fairing hanging bracket comprises a fairing attachment portion and a vehicle attachment portion.

5. The motorcycle fairing attachment assembly of claim 1 wherein the lower fairing support bracket is integrated with the lower fairing support as a single piece, and
said integrated lower fairing support bracket and lower fairing support comprise a fairing attachment portion and a vehicle attachment portion.

6. The motorcycle fairing attachment assembly of claim 3 wherein the fairing attachment portion is angled upward forming an acute angle relative to the vehicle attachment portion, thereby creating a surface to facilitate attachment to the fairing.

7. The motorcycle fairing attachment assembly of claim 1 wherein the front fork assembly comprises an upper triple tree and a lower triple tree.

8. The motorcycle fairing attachment assembly of claim 7 wherein the lower fairing support attaches to the lower triple tree and the upper fairing support plate attaches to the upper triple tree.

9. A motorcycle fairing attachment apparatus comprising:
an attachment apparatus comprising an upper attachment portion and a lower attachment portion;
a fairing; and
a motorcycle comprising a motorcycle frame, a triple tree and a front fork assembly, said triple tree attached to said motorcycle frame so as to permit rotational movement with respect to said motorcycle frame;
wherein the attachment apparatus connects the front fork assembly of the motorcycle to the fairing while allowing free rotational movement of said triple tree with respect to said motorcycle frame without interference with said rotational movement.

10. The motorcycle fairing attachment assembly of claim 9 further comprising a headlight support attached to the fairing hanging bracket.

11. The motorcycle fairing attachment assembly of claim 9 wherein the angle of the headlight support relative to the front fork assembly is adjustable.

12. The motorcycle fairing attachment assembly of claim 9 wherein the fairing hanging bracket comprises a fairing attachment portion and a vehicle attachment portion.

13. The motorcycle fairing attachment assembly of claim 11 wherein the fairing attachment portion is angled upward forming an acute angle relative to the vehicle attachment portion, thereby creating a surface to facilitate attachment to the fairing.

14. The motorcycle fairing attachment assembly of claim 9 wherein the front fork assembly comprises an upper triple tree and a lower triple tree.

15. The motorcycle fairing attachment assembly of claim 13 wherein the lower fairing support attaches to the lower triple tree and the upper fairing support plate attaches to the upper triple tree.

16. A method of attaching a fairing to a motorcycle comprising, without regard to order:
a. attaching a lower fairing support member to the lower end of the front fork assembly of a motorcycle;
b. attaching an upper fairing support plate to the upper end of the front fork assembly of a motorcycle; and further
engaging a fairing, comprising a fairing hanging bracket and a lower fairing support bracket, with said front fork assembly of the motorcycle, such that said lower fairing support member of the motorcycle engages said lower fairing support bracket of the fairing and said upper faring support plate of the motorcycle engages the fairing hanging bracket of said fairing.

17. The method of claim 16, wherein said motorcycle comprises a motorcycle frame, and said triple tree is attached to said motorcycle frame so as to permit rotational movement with respect to said motorcycle frame, whereby the front fork assembly of the motorcycle is connected to the fairing while allowing free rotational movement of said triple tree without interference with said rotational movement.

18. The method of claim 16, further comprising adjustably attaching a headlight support to the fairing support bracket.
